(19) United States
(12) Patent Application Publication
(10) Pub. No.: US 2004/0027734 A1
(43) Pub. Date: Feb. 12, 2004

(54) Load break DC power disconnect

(76) Inventors: Stephen A. Fairfax, Lincoln, MA (US); Neal B. Dowling JR., Sudbury, MA (US); Daniel John Healey, Belmont, MA (US); David S. Kolack, Woodbury, CT (US)

Correspondence Address: CANTOR COLBURN, LLP, 55 GRIFFIN ROAD SOUTH, BLOOMFIELD, CT, 06002

(21) Appl. No.: 10/454,182

(22) Filed: Jun. 3, 2003

Related U.S. Application Data
(60) Provisional application No. 60/385,685, filed on Jun. 4, 2002.

(51) Int. Cl. H02H 3/00

(52) U.S. Cl. 361/2

(57) ABSTRACT

An embodiment of the invention is a DC power disconnect having a first mechanical switch for coupling a DC power module to a first rail of a DC bus and a second mechanical switch for coupling the DC power module to a second rail of the DC bus. A first solid-state switch couples the DC power module to the first rail of the DC bus and is positioned in parallel with the first mechanical switch. A second solid-state switch couples the DC power module to the second rail of the DC bus and is positioned in parallel with the second mechanical switch. A controller initiates closing the first solid-state switch and the second solid-state switch prior to changing state of the first mechanical switch and the second mechanical switch.

### CROSS-REFERENCE TO RELATED APPLICATIONS

This application claims the benefit of U.S. provisional application No. 60/385,685, filed Jun. 4, 2002, the entire contents of which are incorporated herein by reference.

### BACKGROUND OF THE INVENTION

DC buses are used for a variety of power distribution systems. An exemplary system is disclosed in U.S. Pat. No. 6,559,559, the entire contents of which are incorporated herein by reference. Such systems may employ disconnect devices to interrupt power to a DC power module such as a DC load or a DC/DC converter, DC/AC converter, etc.

Mechanical switches for this purpose are large and complicated mechanical devices to handle the large current and to deal with the large arcs that result from interrupting direct currents. Arc suppression mechanisms exist, but are typically complicated. Thus, there is a need for a DC power disconnect system for handling large currents with simple components.

### SUMMARY OF THE INVENTION

An embodiment of the invention is a DC power disconnect having a first mechanical switch for coupling a DC power module to a first rail of a DC bus and a second mechanical switch for coupling the DC power module to a second rail of the DC bus. A first solid-state switch also couples the DC power module to the first rail of the DC bus and is positioned in parallel with the first mechanical switch. A second solid-state switch also couples the DC power module to the second rail of the DC bus and is positioned in parallel with the second mechanical switch. A controller initiates closing the first solid-state switch and the second solid-state switch prior to changing state of the first mechanical switch and the second mechanical switch.

### BRIEF DESCRIPTION OF THE DRAWINGS

FIG. 1 is a block diagram of an exemplary DC power system.

FIG. 2 is a schematic diagram of an exemplary DC power disconnect.

FIG. 3 is a schematic diagram of an exemplary DC power disconnect in an alternate embodiment.

### DESCRIPTION OF THE PREFERRED EMBODIMENTS

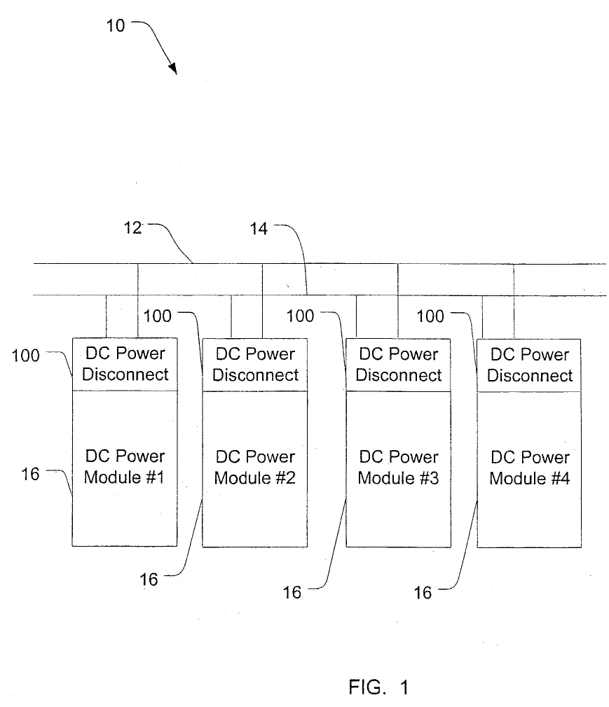

FIG. 1 is a block diagram of an exemplary DC power system 10. The power system includes a DC bus having a negative rail 12 and a positive rail 14. A number of DC power modules 16 are connected to the DC bus through a DC power disconnect 100. DC power modules 16 may be a variety of devices including DC loads or DC power conditioning devices such as DC/DC converters, DC/AC converters, etc. The DC power disconnects 100 are used to disconnect a DC power module 16 from the DC bus for service, upgrade, etc. and then re-connect the DC power module 16 to the DC bus.

In an exemplary embodiment, the DC power modules are part of a power generation system. Thus, it is desirable for the DC power disconnects 100 to operate under load conditions in order to service the DC power modules 16 without interrupting operation. The DC power disconnects 100 may be located physically in the DC main bus, which itself is located in the top section of each DC power module 16. When service and/or maintenance is needed for a particular DC power module 16, the operator will do the following to disconnect the particular module from the main system.

1. Manually operate the DC power disconnect to remove power from the DC power module.

2. Verify visually that the DC power disconnect is open.

3. Perform any required “lock-out/tag-out” procedures.

Reconnecting the DC power module back into the main system will simply require reversing the operation; i.e., arming and closing.

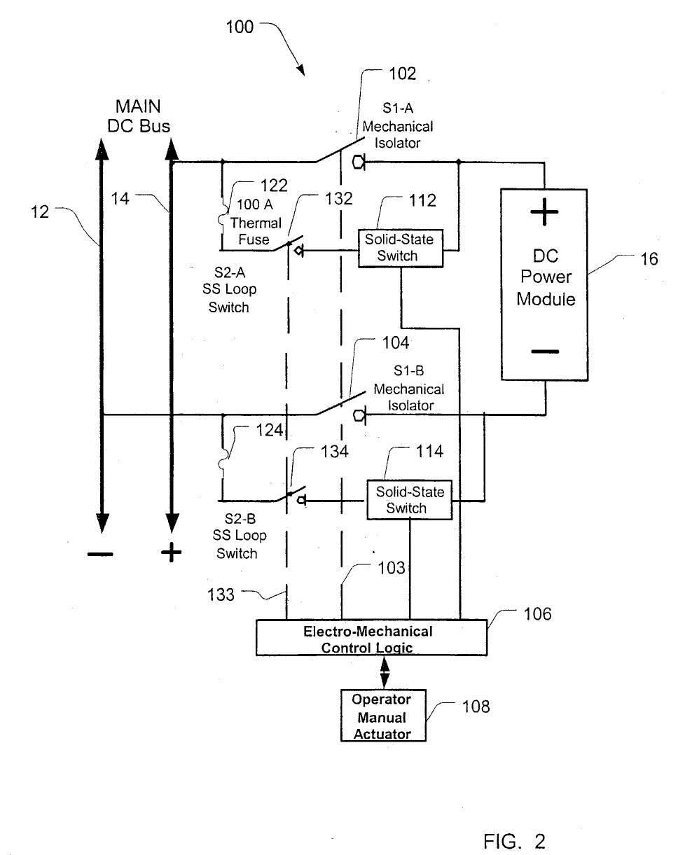

FIG. 2 is a schematic diagram of an exemplary DC power disconnect 100. A DC power module 16 is connected to the positive rail 14 through a first switch 102. DC power module 16 is connected to the negative rail 12 through a second switch 104. The first and second switches 102 and 104 are preferably mechanical switches actuated from controller 106. Switches 102 and 104 may include a cam for activating electrical contact(s), a low contact resistance, and ready-made bus-bar connection points. The cam is coupled to mechanical linkage (e.g., a pneumatic drive mechanism) shown at line 103 that will open and close the switches 102/104 on command from an operator.

In an exemplary embodiment, the first and second switches 102 and 104 have a minimum voltage rating of 600 VDC and a minimum current rating of 6000 ADC. The switch contacts have a resistance of less than 50 μohms. Preferably, switches 102 and 104 include a visible disconnect point and have a contact separation of at least one inch when open. The switches 102 and 104 also provide for the installation of a lock and tag to lock the switching device in the open or closed positions.

An operator interfaces with an operator actuator 108 coupled to the controller 106. An operator issues commands through the operator actuator 108 which are implemented by controller 106. The controller 106 opens and closes switches 102 and 104 as long as certain safety conditions are met. If an unsafe condition is detected, controller 106 prevents operation that will either open or close switches 102 and 104. Prevention of operation is accomplished by means of a positive locking device that will allow operation of the switch only if all conditions are satisfied as described in further detail herein.

Switches 102 and 104 are shunted by a parallel-connected solid-state switches 112 and 114, respectively. In one embodiment, the solid-state switches are insulated gate bipolar transistors (IGBT). The solid-state switches 112 and 114 handle the transition of switches 102 and 104 from open-to-closed contact or from closed-to-open contact. Auxiliary switches 132 and 134 are provided in the shunt path and are controlled by controller 106 as described herein. As with switches 102 and 104, switches 132 and 134 may be opened or closed through a mechanical linkage (e.g., pneumatic drive) shown at line 133 actuated by controller 106.

The solid-state switches 112 and 114 can handle load conduction for a short period of time during the switching transition. However, the solid-state switches 112 and 114 cannot handle sustained loads because of heat build-up in the solid-state element. Fuses 122 and 124 (e.g., thermal fuses) protect solid-state switches 112 and 114, respectively as described herein.

Conversely, the switches 102 and 104 can handle sustained power without requiring any special cooling. However, switches 102 and 104 cannot handle switching transitions because of destructive arcing of the mechanical contacts. Therefore, the combination of mechanical and solid-state switches provides both long-term and low-resistance connection with arc-free switching under load.

Operation of the DC power disconnect 100 will now be described. The connection operation is initiated by an operator at operator actuator 108. Controller 106 receives the command from operator actuator 108 and closes auxiliary switches 132 and 134 to connect the solid-state switches 112 and 114 to the DC bus. Controller 106 confirms that prescribed operational safety conditions are satisfied to continue. Such safety conditions include detecting failures such as a shorted solid-state switch 112/114, a blown fuse 122/124, or a malfunctioning mechanical switch 102/104.

If the safety conditions are met, the controller 106 drives both solid-state switches 112 and 114 into conduction. The controller 106 also starts the closure of switches 102 and 104 to change state from open to closed. When switches 102 and 104 are closed, controller 106 turns off solid-state switches 112 and 114. This allows the transition current from open to closed to be passed through the solid state switches 112 and 114 until switches 102 and 104 are closed.

To disconnect the DC power module 16 from the DC bus, the operator selects the appropriate controls though operator actuator 108. The controller 106 controls the actual switching sequence an initially closes auxiliary switches 132 and 134. Controller 106 verifies that prescribed safety conditions are satisfied and then drives solid-state switches 112 and 114 into conduction. Controller 106 also starts the opening of switches 102 and 104 to change state from closed to open. When the switches 102 and 104 have opened, controller 106 turns off the solid-state switches 112 and 114.

The DC power disconnect 100 provides a number of safety benefits. Main DC bus connections are severed by visible switches 102/104 that are first in line before any of the DC power modules. The thermal fuses 122 and 124 protect the solid state switches 112 and 114 from excessive power dissipation. Thermal fuses 122 and 124 also protect the DC power module 16 in the event that one or both of solid-state switches 112 and 114 is shorted. Auxiliary switches 132 and 134 protect the DC power module 16 from accidental power from the main DC bus, should the solid-state switches 112 and 114 be shorted.

Safety of personnel and equipment is provided by the DC power disconnect. The DC power disconnect has hardware features that allow for the DC power disconnect to be locked in either open or closed positions with proper visibility of the contacts along with any indicators or flags. In addition, the design of the DC power disconnect includes detection features and mechanisms that will prevent manual operation should certain unsafe electrical conditions exist. These conditions would include a shorted solid-state switch, a blown fuse, or a malfunctioning mechanical switch element.

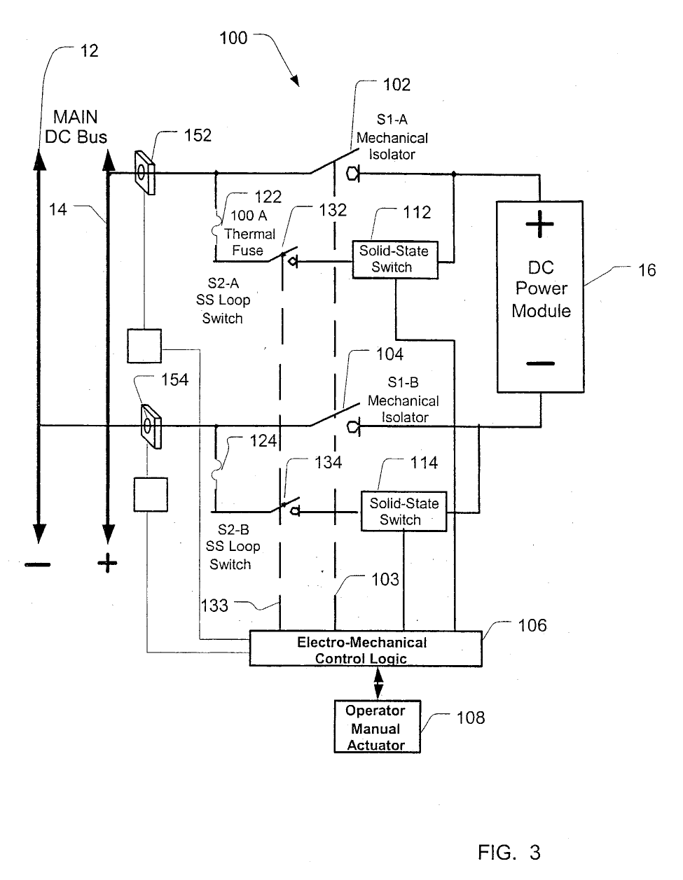

FIG. 3 is a schematic diagram of an exemplary DC power disconnect in an alternate embodiment. The system of FIG. 3 includes current sensors 152 and 154 coupled to controller 106 through signal conditioning devices (e.g., amplifier). In one embodiment, current sensors 152 and 154 are non-contact Hall-effect current sensors. In this embodiment, the DC disconnect operates as a DC circuit breaker by monitoring the current flowing in each switch 102 and 104.

The controller 106 receives a current signal from current sensors 152 and 154. If a fault is detected (e.g., sensed current out of a predefined range), controller 106 closes auxiliary switches 132 and 134. If prescribed safety conditions are satisfied, the controller 106 drives the solid-state switches 112 and 114 into conduction, opens the mechanical switches 102 and 104 and then turns off solid-state switches 112 and 114.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A DC power disconnect comprising:
a first mechanical switch for coupling a DC power module to a first rail of a DC bus;
a second mechanical switch for coupling said DC power module to a second rail of said DC bus;
a first solid-state switch for coupling said DC power module to said first rail of said DC bus, said first solid-state switch positioned in parallel with said first mechanical switch;
a second solid-state switch for coupling said DC power module to said second rail of said DC bus, said second solid-state switch positioned in parallel with said second mechanical switch;
a controller for initiating closing said first solid-state switch and said second solid-state switch prior to changing state of said first mechanical switch and said second mechanical switch.

2. The DC power disconnect of claim 1 further comprising:
a first fuse in series with said first solid-state switch.

3. The DC power disconnect of claim 1 further comprising:
a second fuse in series with said second solid-state switch.

4. The DC power disconnect of claim 1 further comprising:
a first auxiliary switch in series with said first solid-state switch;
said controller closing said first auxiliary switch, determining operational conditions, and changing state of said first mechanical switch in response to said operational conditions.

5. The DC power disconnect of claim 4 wherein:
said determining operational conditions includes detecting a short in said first solid-state switch.

6. The DC power disconnect of claim 4 wherein:
said determining operational conditions includes detecting a malfunction in said first mechanical switch.

7. The DC power disconnect of claim 4 further comprising:
a first fuse in series with said first solid-state switch;
said determining operational conditions includes detecting a blown first fuse.

8. The DC power disconnect of claim 4 further comprising:
a second auxiliary switch in series with said second solid-state switch;
said controller closing said second auxiliary switch and changing state of said second mechanical switch in response to said operational conditions.

9. The DC power disconnect of claim 8 wherein:
said determining operational conditions includes detecting a short in said second solid-state switch.

10. The DC power disconnect of claim 8 wherein:
said determining operational conditions includes detecting a malfunction in said second mechanical switch.

11. The DC power disconnect of claim 8 further comprising:
a second fuse in series with said second solid-state switch;
said determining operational conditions includes detecting a blown second fuse.

12. The DC power disconnect of claim 1 further comprising:
an operator actuator coupled to said controller, said operator actuator initiating said changing state of said first mechanical switch and said second mechanical switch in response to an operator command.

13. The DC power disconnect of claim 1 further comprising:
a mechanical linkage actuated by said controller to simultaneously change said state of said first mechanical switch and said second mechanical switch.

14. The DC power disconnect of claim 8 further comprising:
a mechanical linkage actuated by said controller to simultaneously close said first auxiliary switch and said second auxiliary switch.

15. The DC power disconnect of claim 1 further comprising:
a current sensor monitoring current in said first mechanical switch, said controller initiating opening said first mechanical switch upon detecting a fault current.
